(19) United States
(12) Patent Application Publication
(10) Pub. No.: US 2010/0156352 A1
(43) Pub. Date: Jun. 24, 2010

(54) Controller and Control Method for Charging of the Secondary Battery

(76) Inventors: Koichiro Muta, Okazaki-shi (JP); Ippei Nagao, Nagoya-shi (JP)

Correspondence Address: KENYON & KENYON LLP, 1500 K STREET N.W., SUITE 700, WASHINGTON, DC, 20005, US

(21) Appl. No.: 12/223,855

(22) PCT Filed: Feb. 13, 2007
(86) PCT No.: PCT/IB2007/000333

§ 371 Date: Sep. 19, 2008

(30) Foreign Application Priority Data
Feb. 15, 2006 (JP) 2006-037896

(51) Int. Cl. H02J 7/00

(52) U.S. Cl. 320/134; 180/65.21

(57) ABSTRACT

A charging/discharging controller (2) for a secondary battery (10) including means for determining whether a request for continuous charging/discharging for the secondary battery (10) exists, means for setting a continuous charging/discharging electrical power for the secondary battery (10) within a range smaller than the limited charging/discharging electrical power that is determined periodically or at each point in time according to a battery condition of the secondary battery (10), and means for controlling at least one of the power generated by the electric generating means and the power consumed by the loading means so that electrical power charging/discharging the secondary battery (10) is the continuous charging/discharging electrical power set by the setting means, when the request for continuous charging/discharging is determined to exist by the determining means. The controller (2) inhibits the excessive variation of voltage of the secondary battery (10) when the charging/discharging of the secondary battery (10) continues over a comparatively long period of time, such the time needed to warm the secondary battery (10).

### BACKGROUND OF THE INVENTION

1. Field of the Invention

The present invention relates to a charging/discharging controller for a secondary battery and method for controlling the charging and discharging of the secondary battery, and particularly to a controller and a controlling method that raises the temperature by charging/discharging a secondary battery at a low temperature.

2. Description of the Related Art

A secondary battery is mounted aboard, for example, hybrid vehicle or a fuel cell vehicle that generates electricity while running. In a hybrid vehicle, electrical power stored in the secondary battery is converted to drive power by an electrical motor, and the drive power alone or the drive power combined with the drive power generated by an engine is transmitted to the wheels. In a fuel cell vehicle, depending upon the running condition, in addition to the electrical power generated by the fuel cell, electrical power stored in the secondary battery is applied to the electrical motor, and drive force generated by the electrical motor is transmitted to the wheels.

Because a secondary battery stores electrical energy by a chemical action, the charging/discharging characteristics vary particularly greatly in response to environmental conditions, specifically to the temperature. In particular, at a low temperature the reactivity of the chemical action decreases greatly, so that it is not possible to exhibit the usual performance. For example, if secondary battery capable of supplying approximately 21 kW of electrical power in the optimal temperature range from 20° C. to 40° C. is used at 0° C., it can supply only approximately 5 kW.

For this reason, on early winter mornings or in cold regions, because the secondary battery is at a low temperature, there is the problem of not being able to supply the required electrical power and not being able to start and accelerate smoothly. Given this, as disclosed in the Japanese Patent Application Publication No. JP-A-2000-92614, there is a known device that performs control so that forced charging/discharging of the secondary battery within a prescribed charging/discharging range and the resistive heat that is generated brings the secondary battery to a prescribed temperature, when the temperature of the secondary battery is lower than a prescribed temperature.

Also, the Japanese Patent Application Publication No. JP-A-2003-272712 describes a device in which the charging condition of a battery is repeatedly charged and discharged within a prescribed range when the battery temperature is below a prescribed value. Additionally, Japanese Patent Application Publication No. JP-A-2003-274565 describes a device that causes a secondary battery to generate heat by alternatively causing operation of an electrical generating means that charges an electrical storage section including a secondary battery and a discharging means that discharges electrical power from the storage section.

There has also been description of a device that actively charges a secondary battery to raise the temperature of the secondary battery, without restriction to the repeated charging/discharging conditions in Japanese Patent Application Publication No. JP-A-2000-92614, Japanese Patent Application Publication No. JP-A-2003-272712, and Japanese Patent Application Publication No. JP-A-2003-274565. For example, Japanese Patent Application Publication No. JP-A-7-79503 describes a device that raises the output voltage of an electrical generator in response to the temperature of a secondary battery, to promote generation of heat by charging resistance. Also, Japanese Patent Application Publication No. JP-A-2000-40532 describes a device that sets a high SOC (state of charge) to charge the secondary battery and to promote warmup thereof when the temperature of the engine coolant is low.

In order to improve the charging/discharging performance of a secondary battery, secondary batteries are generally designed to have a small internal resistance. For this reason, as described in JP-A-2000-92614, JP-A-2003-272712, JP-A-2003-274565, JP-A-7-79503, and JP-A-2000-40532, the warming operation of the secondary battery relying on Joule heat in the internal resistance by repeated charging and discharging or active charging, the amount of heat generated per unit time is not that large. The completion of the warming operation up to a normal operating temperature therefore requires a comparatively long time, for example approximately several minutes to between 10 and 20 minutes.

In order to protect the secondary battery there is a limitation of the charging/discharging electrical power of the secondary battery to a charging/discharging electrical power limit determined from the standpoint of the chemical reaction in accordance with state of charge of the secondary battery at various points in time. In the usual warming operation, in order to shorten the warming time, the charging/discharging electrical power is set to coincide with the limited charging/discharging electrical power.

When continuous charging/discharging of a secondary battery is performed within the limited charging/discharging electrical power, however, there were cases in which the polarization action occurring at the electrodes became large, so that an excessive voltage variation (voltage increase or voltage decrease) occurred in the output voltage of the secondary battery as a result of the polarization action. When such an excessive voltage variation occurs in the output voltage of a secondary battery, this variation affects an inverter or electrical motor connected to the secondary battery, thereby causing the problem of a decrease in running performance.

### SUMMARY OF THE INVENTION

The present invention provides a charging/discharging controller for a secondary battery that inhibits an excess variation of voltage of the secondary battery when the charging/discharging of the secondary battery continues over a comparatively long period of time, such as the period of time of a warming operation.

The first aspect of the invention is a charging/discharging controller for a secondary battery in a system having a rechargeable secondary battery, electrical generating means connected to the secondary battery to generate electrical power, and loading means connected to the secondary battery that consumes electrical power. The charging/discharging controller for the secondary battery according to this aspect has means for determining whether or not a request for continuous charging/discharging for the secondary battery exists, means for setting a continuous charging/discharging electrical power for continuously charging/discharging the secondary battery within a range smaller than the limited charging/discharging electrical power to be set periodically or at each point in time according to a battery condition of the secondary battery, and means for controlling at least one of the power generated by the electric generating means and the power consumed by the loading means so that electrical power charging/discharging the secondary battery is the continuous charging/discharging electrical power set by the setting means, when the request for continuous charging/discharging is determined to exist by the determining means.

According to this aspect the continuous charging/discharging electrical power for continuously charging/discharging the secondary battery is set smaller than the limited charging/discharging electrical power that is determined periodically or at each point in time according to a battery condition of the secondary battery when determining means determines that a request for continuous charging/discharging exists. The secondary battery is then continuously charged/discharged using the set continuous charging/discharging electrical power. By doing this, compared with the case in which the secondary battery is continuously charged/discharged using the limited charging/discharging electrical power that is the limited value in short time, a polarization action that occurs in the electrode can be inhibited, because the current flowing in the electrode is small.

Even if the charging/discharging of the secondary battery then continues for a comparatively long period of time, the voltage variation in an output of the secondary battery can be inhibited.

The setting means may set the limited charging/discharging electrical power so as not to exceed the value obtained by multiplying the limited charging/discharging electrical power by a prescribed derating constant.

This aspect may further include a battery temperature sensor, which determines the temperature of the secondary battery, and the determining means may determine that the request for continuous charging/discharging exists if the battery temperature sensor indicates that the temperature of the secondary battery is below a prescribed value.

This aspect may further include a state of charge (SOC) acquisition means for determining the SOC of the secondary battery, and a charging/discharging switching means for deciding whether to execute charging or discharging of the secondary battery so that the SOC of the battery is or is maintained within an acceptable range, and, the determining means may determine a continuous charging electrical power for continuously charging the secondary battery, or a continuous discharging electrical power for continuously discharging the secondary battery according to charging or discharging as decided by the charging/discharging switching means.

The second aspect of the invention relates to a method of controlling the charging/discharging of the secondary battery. The method of controlling the charging/discharging of the secondary battery includes the steps of: determining whether or not a request for continuous charging/discharging for a rechargeable secondary battery exists;

setting a continuous charging/discharging electrical power for continuously charging/discharging the secondary battery within a range smaller than the limited charging/discharging electrical power to be set according to a battery condition of the secondary battery at each point in time; and
controlling at least one of a power generated by an electric generating means, which is connected to the secondary battery to generate electrical power, and a power consumed by a loading means, which is connected to the secondary battery to consume electrical power, so that the electrical power charging/discharging the secondary battery is the continuous charging/discharging electrical power set by the setting step, when the request for continuous charging/discharging is determined to exist.

In a similar fashion, a third aspect of the invention relates to a charging/discharging controller for a secondary battery in a system, comprising a determining apparatus that determines whether a request for continuous charging/discharging for a rechargeable secondary battery exists; a setting apparatus that sets a continuous charging/discharging electrical power for continuously charging/discharging the secondary battery within a range smaller than the limited charging/discharging electrical power to be determined according to a battery condition of the secondary battery at each point in time; and a controller that controls at least one of a power generated by an electric generator, which is connected to the secondary battery to generate electrical power, and a power consumed by a loading apparatus, which is connected to the secondary battery to consume electrical power, so that the electrical power charging/discharging the secondary battery is the continuous charging/discharging electrical power set by the setting apparatus, when the request for continuous charging/discharging is determined to exist by the determining apparatus.

The present invention achieves a charging/discharging controller for a secondary battery that is capable of inhibiting an excess variation of voltage of the secondary battery when the charging/discharging of the secondary battery continues during comparative long period, such as the time of temperature raising operation.

### BRIEF DESCRIPTION OF THE DRAWINGS

The foregoing and further objects, features, and advantages of the invention will become apparent from the following description of preferred embodiments with reference to the accompanying drawings, wherein like numerals are used to represent like elements and wherein:

FIG. 1 is a simplified configuration drawing of a vehicle aboard which is installed a charging/discharging controller for a secondary battery according to an embodiment of the present invention;

FIG. 2 is a simplified configuration of the main parts of the charging/discharging controller for the secondary battery according to an embodiment of the present invention;

FIG. 3 is a drawing for showing an example of a limited charging/discharging electrical power of the secondary battery according to an embodiment of the present invention at a specific temperature;

FIG. 4A and FIG. 4B are drawings for describing cases in which the temperature is raised by continuously charging the secondary battery 10;

FIG. 5A and FIG. 5B are flowcharts for describing a processing flow of determining a continuous charging/discharging electrical power;

FIG. 6A, FIG. 6B and FIG. 6C are drawings for describing an example of time waveforms at various parts accompanying an operation of raising the temperature for the case in which the derating constant is α=1; and

FIG. 7A, FIG. 7B and FIG. 7C are drawings for describing an example of time waveforms at various parts accompanying an operation of raising the temperature for the case in which the derating constant is α=0.5.

### DETAILED DESCRIPTION OF THE PREFERRED EMBODIMENTS

Preferred embodiments of the present invention are described below, with references made to the accompanying drawings. Elements that are the same or similar are assigned the same reference numerals in the drawings, and are not repeatedly described.

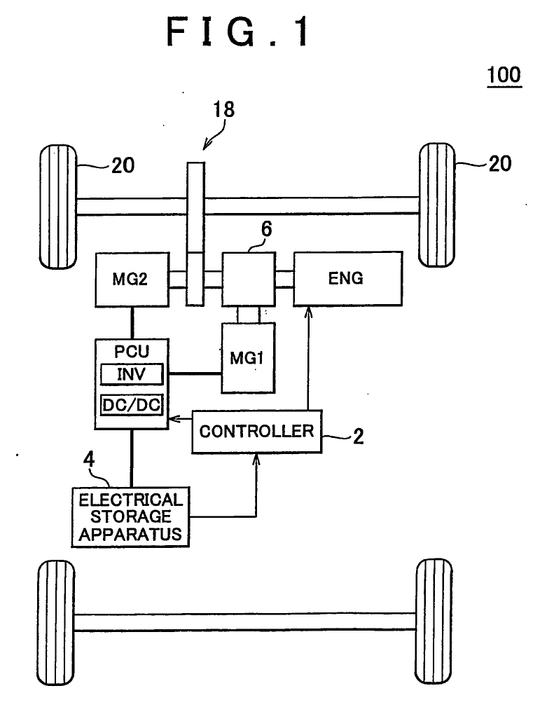

FIG. 1 shows a simplified configuration of a vehicle 100 aboard which is installed a charging/discharging controller for a secondary battery according to an embodiment of the present invention.

The vehicle 100 is an example of a hybrid vehicle that has an engine ENG and motor generators MG1 and MG2. The vehicle 100 includes the engine ENG, a power split device 6, a speed reducer 18, wheels 20, a power control unit PCU, an electrical storage apparatus 4, a controller 2, and motor generators MG1 and MG2.

The engine ENG combusts a gas mixture of fuel and air and causes a crankshaft (not illustrated) to rotate, thereby generating drive power. The drive power generated by the engine ENG is divided into two paths by the drive power split device 6. One path drives the wheels 20, via the speed reducer 18 and the other path drives the motor generator MG1 to generate electricity.

The power control unit PCU is electrically connected to the first motor generator MG1, the second motor generator MG2, and the electrical storage apparatus 4, and performs the mutual exchange and conversion of electrical power, in response to a command from the controller 2. The power control unit PCU includes a voltage converter DC/DC and an inverter INV. The voltage converter DC/DC converts DC electrical power supplied from the electrical storage apparatus 4 to a prescribed voltage and supplies the voltage to the inverter INV, and converts the DC electrical power supplied from the inverter INV to a prescribed voltage and supplies the voltage to the electrical storage apparatus 4. The inverter INV converts the DC electrical power supplied from the voltage converter DC/DC to AC electrical power and performs exchange of the AC electrical power with the motor generator MG1 and the motor generator MG2.

The electrical storage apparatus 4 is electrically connected to the power control unit PCU, stores DC electrical power supplied from the power control unit PCU and supplies stored electrical power to the power control unit PCU. The electrical storage apparatus 4 includes a secondary battery that is formed as a group of a plurality of battery cells connected in series. As described later, the electrical storage apparatus 4 outputs the temperature, the current value, and the voltage value and the like of the secondary battery to the controller 2.

The motor generators MG1 and MG2 are, for example, three-phase AC rotating electrical machines. The second motor generator MG2 is disposed the same rotating shaft as the engine ENG and the drive power split device 6, and exchanges drive power between the engine ENG and the wheels 20. The motor generator MG1 receives the engine drive power that is divided by the drive power split device 6. Although both the motor generators MG1 and MG2 can function as both motors and electrical generators, in the vehicle 100 according to this embodiment of the present invention, the motor generator MG1 functions as an electrical generator and the motor generator MG2 functions as an electrical motor.

By executing a previously stored program the controller 2 performs calculations based on signals transmitted by sensors (not illustrated), the running condition, rate of change in the accelerator angle, the SOC of the electrical storage apparatus 4, and a stored map or the like. By doing this, the controller 2, in response to operations by a driver, controls circuitry and equipment installed aboard the vehicle 100 to achieve a prescribed operating condition of the vehicle 100. As part of this control, when performing chive and regenerative braking of the vehicle 100, respectively, the controller 2 applies a prescribed command to the power control unit PCU to switch the operation of the motor generators MG1 and MG2.

As an example, when driving the vehicle 100, the motor generator MG2 receives AC power supplied from the power control unit PCU and generates drive power. When this is done, the drive power generated by the motor generator MG2 is transmitted to the wheels 20 via the speed reducer 18. Additionally, the engine ENG is switched between the operating and stopped conditions in response to the running condition. The vehicle 100, therefore, receives drive power from at least one of the motor generator MG2 and the engine ENG. A part of the electrical power generated by the motor generator MG1, after conversion to DC power by the power control unit PCU, is stored in the electrical storage apparatus 4, and the other part is supplied to the motor generator MG2 via the power control unit PCU.

During regenerative braking of the vehicle 100, the motor generator MG2 is driven by the wheels 20 via the speed reducer 18 and operates as an electrical generator. That is, the motor generator MG2 operates as a regenerative brake that converts braking energy to electrical power. The electrical power generated by the motor generator MG2, after conversion to DC electrical power by the power control unit PCU, is stored in the electrical storage apparatus 4.

The term regenerative braking as used herein includes braking accompanied by regenerative braking in the case of a brake pedal operation by the driver of the hybrid vehicle, and also includes speed reduction (or stopping of acceleration) while performing regenerative braking by setting the accelerator pedal to off during running, without operating the brake pedal.

Additionally, the controller 2 judges whether or not a continuous charging/discharging request has been made for the electrical storage apparatus 4 that includes a secondary battery 10 exists and, if the judgment is made that a continuous charging/discharging request exists, determines the continuous charging/discharging electrical power for charging/discharging the secondary battery 10 continuously, so that it is smaller than the charging/discharging electrical power limit. The term continuous charging/discharging electrical power used herein includes the continuous charging electrical power #WIN for continuous charging and the continuous discharging electrical power #WOUT for continuous discharging.

The controller 2 controls at least one of the electrical power generated by and consumed by the motor generators MG1 and MG2 so that the electrical power that is continuously charged to and discharged from the secondary battery 10 is the determined continuous charging/discharging electrical power. At the same time, the controller 2 calculates the output required from the engine ENG and issues an rpm command to the engine ENG, based on the electricity generated by and consumed by the motor generators MG1 and MG2. That is, the controller 2 generally increases the engine output when the secondary battery is being charged, and decreases the engine output when the secondary battery is being discharged.

The charging/discharging control of the secondary battery in this embodiment of the present invention is implemented by execution of a program previously stored by the controller 2.

As an example of continuous charging/discharging of the secondary battery 10, in this embodiment of the present invention, if the temperature of the secondary battery 10 is lower than the minimum value ideal for operation (minimum operating temperature), the temperature of the secondary battery 10 is raised to the minimum operating temperature by Joule heat from the internal resistance when continuously charging/discharging the secondary battery 10.

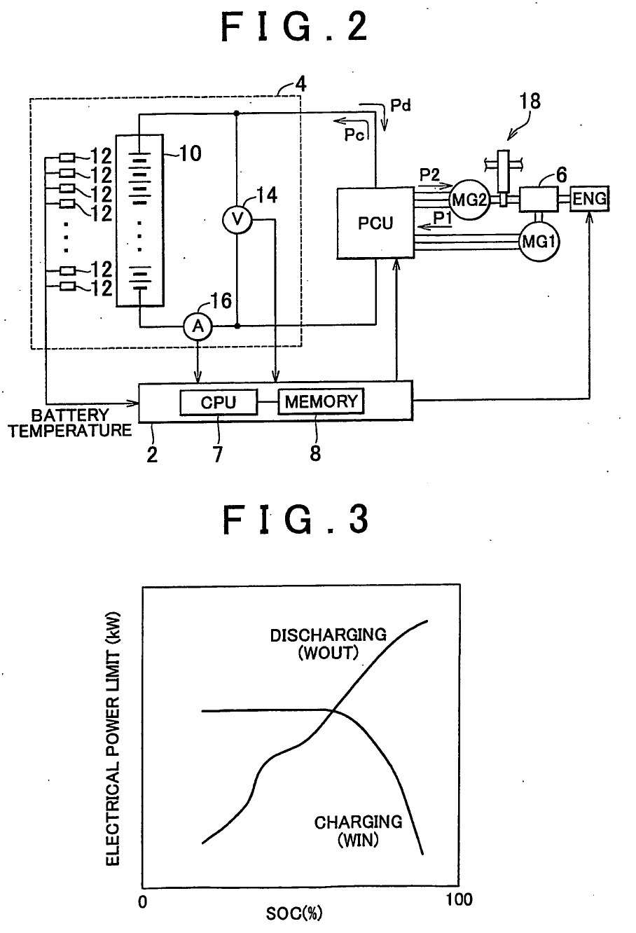

FIG. 2 is a simplified configuration drawing showing the main parts of the charging/discharging controller for a secondary battery according to this embodiment of the present invention.

The electrical storage apparatus 4 is electrically connected to the power control unit PCU and exchanges DC electrical power with the power control unit PCU. The electrical storage apparatus 4 has a secondary battery 10, a voltage value detector 14 that detects the voltage value at an output terminal of the secondary battery 10, a current value detector 16 that detects the value of current flowing into and out of the secondary battery 10, and temperature sensors 12 that detect the temperature of each cell of the secondary battery 10. Batteries that may be suitably used as a secondary battery include, for example, lithium ion batteries and nickel hydrogen batteries.

An example of the controller 2 is an ECU (electrical control unit), which includes a CPU (central processing unit) 7, a memory 8 that is RAM (random access memory) or a ROM (read only memory) or the like. If the temperature of the secondary battery 10 acquired from the temperature sensors 12 is below the minimum operating temperature, the controller 2, in response to the SOC of the secondary battery 10, charges or discharges the secondary battery 10 continuously.

In a typical hybrid vehicle, it is necessary to maintain a condition in which, in response to an operation by the driver, driving electrical power can be supplied to the motor generator MG2 and regeneratively generated electrical power from the motor generator MG1 can be stored in the electrical storage apparatus 4. To do that, the charging/discharging electrical power of the secondary battery 10 is controlled so that the SOC thereof is within an acceptable range (for example, 40% to 60%). This being this case, if the SOC of the secondary battery 10 is below the lower limit value of an acceptable SOC range (SOC lower limit value) the secondary battery 10 is continuously charged with the continuous charging electrical power #WIN (hereinafter “charging mode”) and if the SOC of the secondary battery 10 is above the upper limit value of an acceptable SOC range (SOC upper limit value) the secondary battery 10 is continuously discharged with the continuous discharging electrical power #WOUT (hereinafter “discharging mode”).

That is, if the electrical power generated by the motor generator MG1 is P1 [kW] (with generated power taken as a positive value) and the electrical power consumed by the generation of driving power by the motor generator MG2 is P2 [kW] (with consumed power taken as a positive value), when there is no loss in the power control unit PCU the charging electrical power Pc [kW] that charges the secondary battery 10 is Pc [kW]=P1−P2 (where P1>P2), and the discharging electrical power discharged from the secondary battery 10 is Pd [kW]=P2−P1 (where P2>P1).

In the charging mode, the controller 2 issues a torque command and an rpm command and the like to the power control unit PCU so that the charging electrical power Pc is the continuous charging electrical power #WIN, and controls at least one of the electrical powers P1 and P2 of the motor generators MG1 and MG2.

In the discharging mode, however, the controller 2 issues a torque command and an rpm command and the like to the power control unit PCU so that the discharging electrical power Pd is the continuous discharging electrical power #WOUT, and controls at least one of the electrical powers P1 and P2 of the motor generators MG1 and MG2.

If the vehicle 100 is moving, it is necessary to generate drive power for the vehicle 100 that is required by an operation made by a driver, that is, drive power that is transmitted to the wheels 20 via the speed reducer 18 (FIG. 1). For this reason, the controller 2 determines the overall total of the drive power generated by the motor generator MG2 and the drive power generated by the engine ENG and the ratio therebetween, based on a pre-determined map or the like, and to both issue torque and rpm commands to the power control unit PCU and issue an rpm command to the engine ENG.

In a configuration in which the SOC of the secondary battery 10 is acquired, various known art can be used. One example is that of the controller 2 deriving the open-circuit voltage OCV of the secondary battery 10 at each point in time from the voltage value and the current value detected, respectively, from the voltage value detector 14 and current value detector 16, and applying this open-circuit voltage OCV to charging/discharging characteristics that show the relationship between the SOC and the open-circuit voltage OCV at a reference condition of the secondary battery 10 measured experimentally beforehand, thereby acquiring the SOC of the secondary battery 10. Additionally, the SOC acquired based on the reference charging/discharging characteristics may be corrected, using an accumulated value of the input and output currents of the secondary battery 10. Because a configuration that acquires the SOC in this manner is known, it is not described herein.

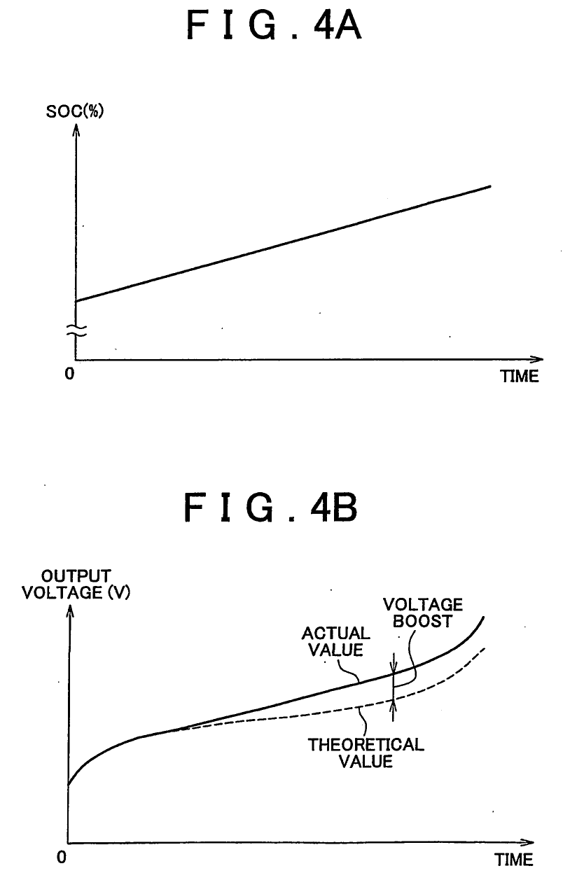

FIG. 3 shows an example of a limited charging/discharging electrical power of the secondary battery 10 at a specific temperature.

Referring to FIG. 3, in the secondary battery 10, the charging electrical power limit WIN and discharging electrical power limit WOUT, which are short-term limit values at each point in time, are determined in response to the limit of the chemical reaction of the secondary battery 10. The term charging/discharging electrical power limit used herein includes the charging electrical power limit WIN and the discharging electrical power limit WOUT.

The charging electrical power limit WIN and the discharging electrical power limit WOUT are determined in accordance with the SOC of the secondary battery 10. In the case of a lithium ion battery, for example, these are determined so that the upper voltage limit and lower voltage limit for each cell are 4.2 V and 3.0 V, respectively. Also, the charging/discharging electrical power limit varies greatly depending upon the temperature of the battery.

For this reason, the controller 2 stores a map of the charging/discharging power limit that is defined by the SOC and the battery temperature of the secondary battery 10 acquired experimentally beforehand, and acquires the charging/discharging electrical power limit for each point in time, based on the acquired SOC and the battery temperature. The controller 2 limits the charging electrical power and the discharging electrical power of the secondary battery 10 so that the charging/discharging electrical power limit is not exceeded. The map that defines the charging/discharging electrical power limit may be made to include a parameter other than the SOC and the battery temperature, such as the degree of deterioration of the secondary battery 10.

Because the charging/discharging electrical power limit is a short-term limit value at each point in time, if the secondary battery 10 is continuously discharged with no particular limitation in the range of the charging/discharging electrical power limit, a large polarization action occurs, and there is an excessive variation in the output voltage of the secondary battery.

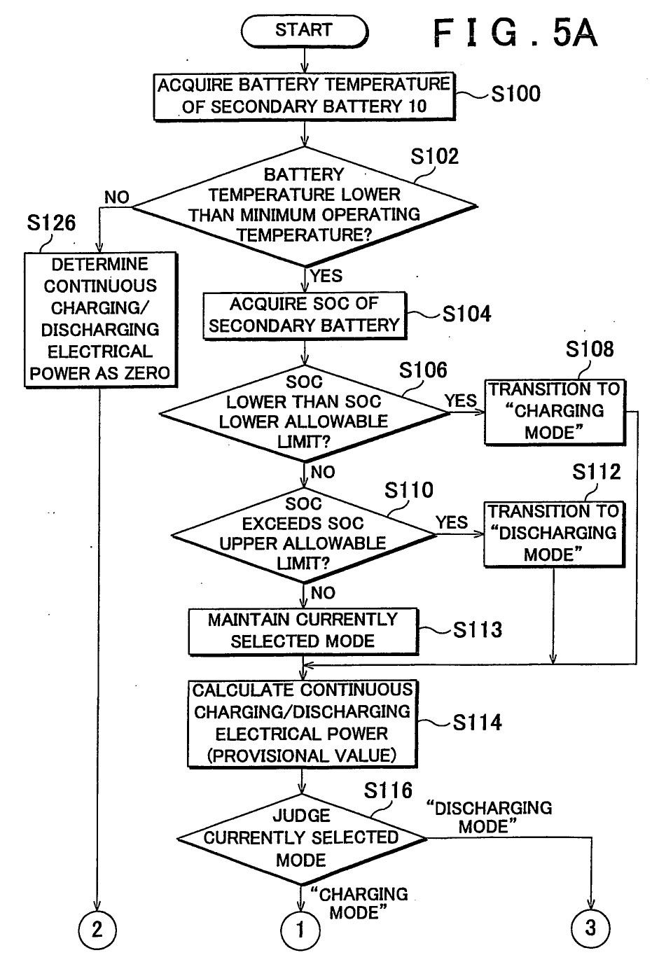

FIG. 4A and FIG. 4B describe the change in the cases in which the secondary battery 10 is continuously charged at the charging electrical power limit accompanying the elapse of time.

FIG. 4A shows the change in the SOC of the secondary battery 10 over time. FIG. 4B shows the change in the output voltage of the secondary battery 10 over time.

If the secondary battery 10 is continuously charged at the charging electrical power limit WIN, the SOC of the secondary battery 10 monotonically increases with an increase in the charging time.

With an increase in the SOC of the secondary battery 10, as shown in FIG. 4A, the output voltage of the secondary battery 10 theoretically increases in accordance with a reference charging/discharging characteristic (theoretical value). However, the output voltage actually exhibited by the secondary battery 10, as shown in FIG. 4B, sometimes shows an excessive increase in voltage in comparison to the theoretical value. This is thought to be due to a continuous charging power (charging current) over a long period of time, there is a large polarization action that occurs.

In contrast, if the secondary battery 10 is continuously discharged at the discharging electrical power limit WOUT, there are cases in which the output voltage of the secondary battery 10 shows an excessive voltage drop relative to the theoretical value. With regard to this phenomenon as well, it is thought that the cause is that, because of a continuous discharging power (discharging current) over a long period of time, there is a large polarization action that occurs.

In this manner, even when the charging electrical power and the discharging electrical power are limited to the charging/discharging electrical power limits at each point in time, there are cases in which an excessive variation in voltage occurs. This is because, for the purpose of protecting the secondary battery 10, the charging/discharging electrical power limits are determined as “short-term” limit values based on the battery condition at each point in time, which does not take into consideration continuous charging and discharging.

Given this, the controller 2 according to this embodiment of the present invention determines the continuous charging/discharging electric power to be smaller than the charging/discharging electrical power limit in the case in which there is a continuous charging/discharging request for charging/discharging of the secondary battery 10, such as when raising the temperature of the secondary battery 10. Specifically, the controller 2 determines the continuous charging/discharging electrical power so as not to exceed a value of derated electrical power obtained by multiplying the charging/discharging electrical power limit at each point in time by a prescribed derating constant α (where 0<α<1).

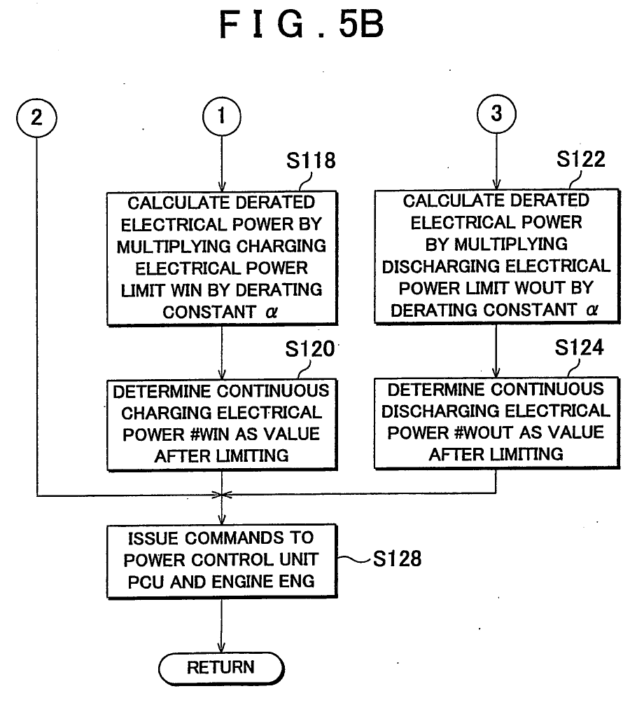

FIG. 5A and FIG. 5B are flowcharts showing the process related to determining the continuous charging/discharging electrical power.

As an example in which there is a continuous charging/discharging request for the secondary battery 10, in the case in which the temperature of the secondary battery 10 is lower than the minimum value of the optimal operation temperature (minimum operating temperature), the controller 2 determines whether there is the need to raise the temperature of the secondary battery 10. The controller 2 first acquires the temperature of the secondary battery 10 from the temperature sensors 12 (step S100). Then the controller 2 determines whether the acquired battery temperature is below the minimum operating temperature, in order to determine whether it is necessary to raise the temperature of the secondary battery 10 (step S102).

If the battery temperature is below the minimum operating temperature (YES at step S102), the controller 2 determines that a continuous charging/discharging request exists for the secondary battery 10, and acquires the SOC of the secondary battery 10 (step S104). The controller 2 then determines whether the SOC of the secondary battery 10 is below the SOC lower limit value (step S106).

If the SOC of the secondary battery 10 is below the SOC lower limit value (YES at step S106), the controller 2 transitions to the “charging mode” to continuously charging the secondary battery 10 (step S108).

If the SOC of the secondary battery 10 is at or above the SOC lower limit value (NO at step S106), the controller 2 determines whether the SOC of the secondary battery 10 exceeds the SOC upper limit value (Step S110).

If the SOC of the secondary battery 10 exceeds the SOC upper limit value (YES at step S110), the controller 2 transitions to the “discharging mode” to continuously discharging the secondary battery 10 (step S112).

If the SOC of the secondary battery 10 is at or above the SOC lower limit value (NO at step S106) and also does not exceed the SOC upper limit value (NO at Step S110), the controller 2 maintains the currently selected mode (step S113). For example, immediately after the ignition is switched on, because there are cases in which the mode selected by the controller 2 is indeterminate, one or the other mode (for example, the charging mode) may be pre-selected as the initialized value.

The controller 2 then calculates the continuous charging/discharging electrical power (provisional value) for the secondary battery 10 (step S114). The provisional value of the continuous charging/discharging electrical power is determined in accordance with, for example, the difference between the battery temperature of the secondary battery 10 and the minimum operating temperature, the internal resistance value of the secondary battery 10, and the outside air temperature. The controller 2 then determines whether the currently selected mode is the “charging mode” or the “discharging mode” (step S116).

If the currently selected mode is “charging mode,” (“charging mode” at step S116), the controller 2 calculates the derated electrical power (charging mode) by multiplying the charging electrical power limit WIN corresponding to the current SOC by the derating constant α (step S118). The controller 2 then limits the continuous charging/discharging electrical power (provisional value) so as not to exceed the calculated derated electrical power (charging mode), and determines the continuous charging electrical power #WIN as the value after that limiting (step S120).

If the currently selected mode is “discharging mode,” (“discharging mode” at step S116), the controller 2 calculates the derated electrical power (discharging mode) by multiplying the charging electrical power limit WOUT corresponding to the current SOC by the derating constant α (step S122). As an example, the derating constant α is taken as 0.5 or the like.

The controller 2 then limits the continuous charging/discharging electrical power (provisional value) so as not to exceed the calculated derated electrical power (discharging mode), and determines the continuous discharging electrical power #WOUT as the value after that limiting (step S124).

If the battery temperature is at or above the minimum operating temperature (NO at step S102), the controller 2 determines that a continuous charging/discharging request for the secondary battery 10 does not exist and sets the continuous charging/discharging electrical power as zero (step S126).

After setting the continuous charging/discharging electrical power (continuous charging electrical power #WIN or continuous discharging electrical power output #WOUT) at steps S120, S124, and S126, the controller 2 creates a final command, by adding, to a request in accordance to an operation by the driver, a request by the continuous charging/discharging electrical power, and issues the command to the power control unit PCU and the engine ENG (step S128).

After the above the controller 2 repeats execution of the above-described process sequentially or at a prescribed interval.

In the above-described flowchart, although the example given is one in which the derating constant α is a fixed value, there is no restriction to this, and derating constant α may change in response to a time needed to raise the temperature of the secondary battery 10 predicted from difference in temperature between the temperature of the secondary battery 10 and the minimum operating temperature, and the outside air temperature, this being duration time of discharging.

Also, in the above-described flowchart although the example given is one in which, regardless of whether the mode is the charging mode or the discharging mode, the continuous charging/discharging electrical power (provisional value) is uniformly calculated (step S 114), alternatively the continuous charging electrical power (provisional value) or continuous discharging electrical power (provisional value) may be independently calculated for the charging and discharging modes, respectively.

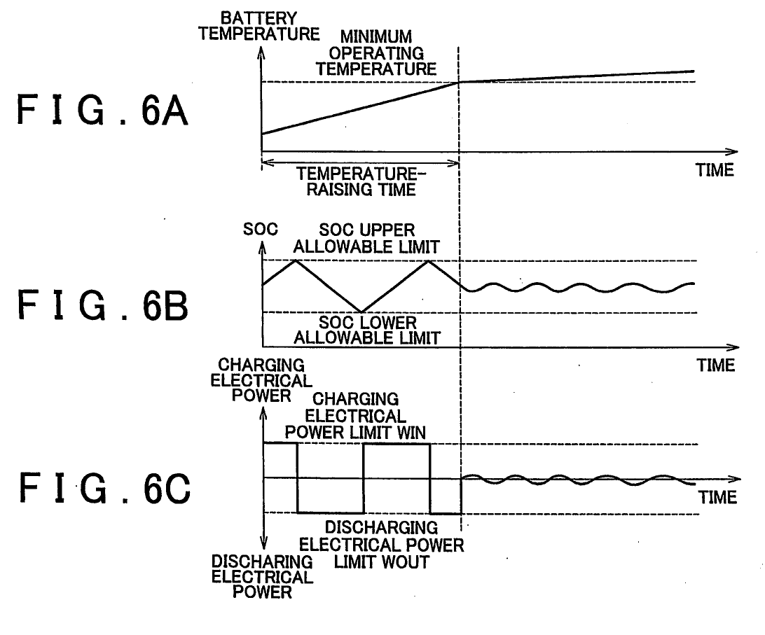

FIG. 6A, FIG. 6B, and FIG. 6C show examples of the time waveforms at various time points accompanying a rise in temperature for the case in which the derating constant α=1.

FIG. 6A shows the change in battery temperature of the secondary battery 10 over time. FIG. 6B shows the change in the SOC of the secondary battery 10 over time.

FIG. 6C shows the change in the charging/discharging electrical power of the secondary battery 10 over time. As shown in FIG. 6A, when, for example, the ignition is turned on, if the temperature of the secondary battery 10 is below the minimum operating temperature, the controller 2 starts raising the temperature of the secondary battery 10.

As shown in FIG. 6B, when the ignition is turned on, the controller 2 supplies the secondary battery 10 with the continuous charging electrical power #WIN with the acceptable limit of the SOC thereof, to start charging (charging mode). After that, when the SOC of the secondary battery 10 exceeds to the SOC upper limit value, the controller 2 transitions to the discharging mode, and causes discharging of the continuous discharging power #WOUT from the secondary battery 10. After that, the controller 2 alternates between the charging mode and the discharging mode, to maintain the SOC of the secondary battery 10 within the SOC allowable limit, while raising the temperature of the secondary battery 10 to the minimum operating temperature.

As shown in FIG. 6C, in the case in which the derating constant α is 1, that is, if the continuous charging/discharging electrical power is allowed up to the charging/discharging electrical power limit at the current point in time (charging electrical power limit WIN or discharging electrical power limit WOUT), a charging/discharging electrical power coinciding with the charging/discharging electrical power limit is generated at the secondary battery 10. For this reason, there are cases in which, as described above, the secondary battery 10 exhibits an excessive variation in voltage.

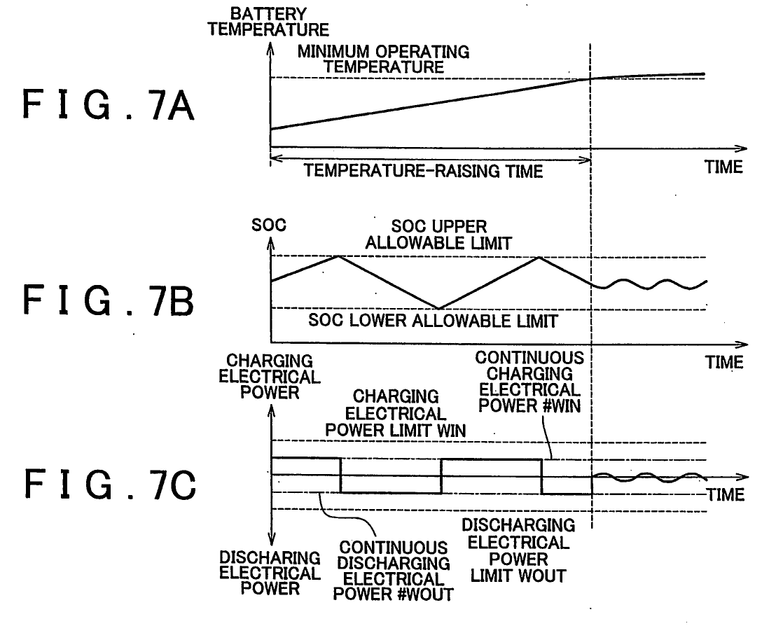

FIG. 7A, FIG. 7B, and FIG. 7C show examples of the time waveforms at various locations accompanying a rise in temperature for the case in which the derating constant α=0.5.

FIG. 7A shows the change in battery temperature of the secondary battery 10 over time. FIG. 7B shows the change in the SOC of the secondary battery 10 over time.

FIG. 7C shows the change in the charging/discharging electrical power of the secondary battery 10 over time. As shown in FIG. 7A and FIG. 7B, similar to the cases of FIG. 6A and FIG. 6B, at the point in time, for example, when the ignition is turned on, if the battery temperature of the secondary battery 10 is below the minimum operating temperature, the controller 2 starts raising the temperature of the secondary battery 10 while maintaining the SOC of the secondary battery 10 within the SOC allowable limit.

In FIG. 7C, because the derating constant α is 0.5, the continuous charging/discharging electrical power of the secondary battery 10 (continuous charging electrical power #WIN or continuous discharging electrical power #WOUT) is limited to 50% of the charging/discharging electrical power limit (charging electrical power limit WIN or discharging electrical power limit WOUT) at the current point in time. As a result, because the value of current flowing in the secondary battery 10 decreases, the polarization action at the electrode part is inhibited, and it is possible to avoid an excessive voltage variation in the secondary battery 10. Thus, even if there is a continuous charging/discharging request for the secondary battery 10, such as when raising the temperature of the secondary battery 10, the running performance of the vehicle 100 is not caused to deteriorate.

Furthermore, because the charging/discharging electrical power with respect to the secondary battery 10 is reduced from the charging/discharging electrical power limit to the continuous charging/discharging electrical power, the time for raising the temperature (continuous discharging time of the secondary battery 10) is long compared to the case of FIGS. 6A, 6B, 6C. However, with regard to the degree of polarization action occurring in the secondary battery 10, because the effect of reducing the current flowing in the electrodes is greater, compared with the case of FIG. 6A, 6B, 6C there is a reduction in the polarization action. For this reason, it is possible to inhibit variation in the voltage of the secondary battery 10.

Although in this embodiment of the present invention it is possible to implement an “electrical generating means” and a “loading means” by the motor generators MG1 and MG2, in many instances the motor generator MG1 implements an “electrical generating means,” and the motor generator MG2 implements a “loading means.” The controller 2 implements a “judging means,” a “determining means,” a “controlling means,” a “battery temperature acquisition means,” and a SOC acquisition means.”

According to this embodiment of the present invention, the continuous charging/discharging electrical power is determined to be smaller than the charging/discharging electrical power limit in the case in which there is a continuous charging/discharging request for the secondary battery 10, such as when raising the temperature of the secondary battery early on a winter morning or in a cold region. Also, because the secondary battery is continuously charged and discharged with this determined continuous charging/discharging electrical power, compared to the case in which continuous charging/discharging is done with the charging/discharging electrical power limit, it is possible to inhibit the polarization action occurring in the secondary battery. For this reason, when the secondary battery is continuously charged and discharged, it is possible to reduce the excessive variation in voltage of the secondary battery due to the polarization.

It is therefore possible to inhibit the affect of an excessive voltage variation on an inverter or electrical motor, and to achieve stable running performance on early winter mornings and in cold regions.

Although this embodiment of the present invention was described for the example of a hybrid vehicle in which a secondary battery according to the present invention is installed, the present invention is not limited to a hybrid vehicle, and application thereof may be made to a system having a secondary battery and having also an electrical generating means and a loading means. As one example, application is possible to a fuel cell vehicle aboard which a fuel cell is installed.

While the invention has been described with reference to the embodiments, it is to be understood that the invention is not limited to the example embodiments. The scope of the present invention is not defined by the description thereof, but rather by the following claims, and includes any changes, modifications, improvements and/or equivalent arrangements, which occur to those skilled in the art without departing from the scope of the invention.

1. (canceled)

2. The charging/discharging controller for a secondary battery according to claim 5 wherein the setting apparatus sets the limited charging/discharging electrical power to a value that is equal to or less than a value obtained by multiplying the limited charging/discharging electrical power by a prescribed derating constant.

3. The charging/discharging controller for a secondary battery according to claim 5, further comprising a battery temperature acquisition apparatus for acquiring a battery temperature for the secondary battery, wherein the determining apparatus determines that the request for continuous charging/discharging exists if the battery temperature acquired by the battery temperature acquisition apparatus is below a prescribed value.

4. The charging/discharging controller for a secondary battery according to claim 5 further comprising:
a state of charge (SOC) acquisition apparatus for acquiring the state of charge of the secondary battery; and
a charging/discharging switching apparatus for deciding whether to execute charging or discharging of the secondary battery so that the state of charge acquired by the state of charge acquisition apparatus is within an acceptable range,
wherein the setting apparatus sets a continuous charging electrical power for continuously charging the secondary battery, or a continuous discharging electrical power for continuously discharging the secondary battery according to charging or discharging as decided by the charging/discharging switching apparatus.

5. A charging/discharging controller for a secondary battery in a system comprising:
a determining apparatus that determines whether a request for continuous charging/discharging for a rechargeable secondary battery exists based on the information that the temperature of the secondary battery is below a minimum operating temperature;
a setting apparatus that sets a continuous charging/discharging electrical power for continuously charging/discharging the secondary battery within a range smaller than the limited charging/discharging electrical power to be determined according to a battery condition of the secondary battery at each point in time; and
a controller that controls at least one of a power generated by an electric generator, which is connected to the secondary battery to generate electrical power, and a power consumed by a loading apparatus, which is connected to the secondary battery to consume electrical power, so that the electrical power charging/discharging the secondary battery is the continuous charging/discharging electrical power set by the setting apparatus, when the request for continuous charging/discharging is determined to exist by the determining apparatus.

6. A method of controlling charging/discharging of a secondary battery in a system, comprising the steps of:
determining whether a request for continuous charging/discharging for a rechargeable secondary battery exists based on the information that the temperature of the secondary battery is below a minimum operating temperature;
setting a continuous charging/discharging electrical power for continuously charging/discharging the secondary battery within a range smaller than the limited charging/discharging electrical power to be determined according to a battery condition of the secondary battery at each point in time; and
controlling at least one of a power generated by an electric generating apparatus, which is connected to the secondary battery to generate electrical power, and a power consumed by a loading apparatus, which is connected to the secondary battery to consume electrical power, so that the electrical power charging/discharging the secondary battery is the continuous charging/discharging electrical power set by the setting step, when the request for continuous charging/discharging is determined to exist.
